(19) United States
(12) Patent Application Publication
(10) Pub. No.: US 2021/0024790 A1
(43) Pub. Date: Jan. 28, 2021

(54) RESIN COMPOSITION, GAP-FILLING ADHESIVE, PRODUCTION METHOD OF GAP-FILLING ADHESIVE, AND GAP FILLING METHOD

(71) Applicant: 3M INNOVATIVE PROPERTIES COMPANY, St. Paul, MN (US)

(72) Inventors: Kenji Wakamatsu, Tokyo (JP); Tomoaki Uchiya, Tokyo (JP)

(21) Appl. No.: 16/967,297

(22) PCT Filed: Feb. 5, 2019
(86) PCT No.: PCT/IB2019/050903

§ 371 Date: Aug. 4, 2020

(30) Foreign Application Priority Data
Feb. 6, 2018 (JP) 2018-019457

(51) Int. Cl. C09J 133/08

(52) U.S. Cl. CPC C09J 133/08

(57) ABSTRACT

A resin composition, including a radical-polymerizable compound, a cation-polymerizable compound, a photo radical photopolymerization initiator, and a photo cation photopolymerization initiator; wherein the resin composition has a range of wavelengths so that one of the photo radical photopolymerization initiator and the photo cation photopolymerization initiator has a molar absorption coefficient of 1 or greater, and the other has a molar absorption coefficient of 0.1 or less. A gap-filling adhesive which is a partially polymerized product of the resin composition. The gap-filling adhesive is capable of easily filling the gap in the body to be adhered.

### TECHNICAL FIELD

The present invention relates to a resin composition, a gap-filling adhesive, a production method of the gap-filling adhesive, and the filling method of the gap.

### BACKGROUND ART

In the related art, filling a gap of any structure such as a recess with filler is performed in order to improve the design of the structure. As an example of the filler, Patent Document JP H10-36815A discloses that sodium hydrogen carbonate is formulated as a curable binding formulation for binding and finishing a connecting part between plaster dry wall panels.

### SUMMARY OF THE INVENTION

An object of the present invention is to provide a gap-filling adhesive being capable of easily filling the gap in the body to be adhered. Another object of the present invention is to provide a resin composition from which a gap-filling adhesive having a three-dimensional shape corresponding to the gap in the body to be adhered can be easily obtained. A further object of the present invention is to provide a production method of the gap-filling adhesive by using the resin composition, and to provide a filling method of the gap by using the gap-filling adhesive.

An aspect of the present invention relates to a resin composition, including a radical-polymerizable compound, a cation-polymerizable compound, a photo radical photopolymerization initiator, and a photo cation photopolymerization initiator; wherein the resin composition has a range of wavelengths such that one of the photo radical photopolymerization initiator and the photo cation photopolymerization initiator has a molar absorption coefficient of 1 or greater, and the other has a molar absorption coefficient of 0.1 or less.

Another aspect of the present invention relates to a gap-filling adhesive which is a partially polymerized product of the resin composition, wherein the gap-filling adhesive includes a polymer of the radical-polymerizable compound, the cation-polymerizable compound, and the photo cation photopolymerization initiator, or the gap-filling adhesive comprises the radical-polymerizable compound, the polymer of the cation-polymerizable compound, and the photo radical photopolymerization initiator.

A further aspect of the present invention relates to a production method of the gap-filling adhesive, including a partially curing step of partially curing the resin composition with the light having the certain range of wavelengths.

A still further aspect of the present invention is to provide a filling method of the gap, including a filling step of filling the gap with the gap-filling adhesive; and a curing step of curing the gap-filling adhesive filled in the gap.

According to the present invention, provided is the gap-filling adhesive being capable of easily filling the gap in the body to be adhered. Further, according to the present invention, provided is the resin composition from which a gap-filling adhesive having a three-dimensional shape corresponding to the gap in the body to be adhered can be easily obtained. Further, according to the present invention, provided is a production method of the gap-filling adhesive by using the resin composition, and a filling method of the gap by using the gap-filling adhesive.

### BRIEF DESCRIPTION OF THE DRAWINGS

FIG. 1A is a schematic perspective view showing one embodiment of the gap-filling adhesive. FIGS. 1B and 1C are schematic perspective views illustrating other embodiments of the gap-filling adhesive.

FIGS. 2A, 2B, and 2C are cross-sectional views illustrating steps according to one embodiment of the production method of the gap-filling adhesive.

FIGS. 3A, 3B, and 3C are cross-sectional views illustrating steps according to one embodiment of the filling method of the gap.

FIGS. 4A and 4B are schematic cross-sectional views illustrating the structure of an exterior panel as one component of a vehicle body.

### DESCRIPTION OF PREFERRED EMBODIMENTS

Preferred embodiments of the present invention are described below with reference to the drawings. Note that identical elements have been assigned identical codes in the explanation of the drawings, and a duplicate explanation is omitted. Furthermore, the drawings are drawn with a portion embellished in order to ease understanding, and the dimensional ratios and the like are not limited to those illustrated in the drawings.

### Resin Composition

The resin composition according to the embodiment includes a radical-polymerizable compound, a cation-polymerizable compound, a photo radical photopolymerization initiator, and a photo cation photopolymerization initiator. The resin composition according to the embodiment has a range of wavelengths so that one of the photo radical photopolymerization initiator and the photo cation photopolymerization initiator has a molar absorption coefficient of 1 or greater, and the other has a molar absorption coefficient of 0.1 or less. In other words, in a certain range of wavelengths, one of the photo radical photopolymerization initiator and the photo cation photopolymerization initiator has a molar absorption coefficient of 1 or greater, and the other has a molar absorption coefficient of 0.1 or less.

The resin composition according to the embodiment includes the photo radical photopolymerization initiator and the photo cation photopolymerization initiator in which these initiators have substantially different molar absorption coefficients within the certain range of wavelengths. Therefore, by irradiating the resin composition with a light having the certain range of wavelengths, only one of the photo radical photopolymerization initiator and the photo cation photopolymerization initiator can be activated. That is, from the resin composition according to the embodiment, a partially cured product can be obtained by polymerizing one of the radical-polymerizable compound and the cation-polymerizable compound when a light having the certain range of wavelengths was irradiated. The partially cured product can be suitably used as a gap-filling adhesive being capable of curing by light irradiation.

In the embodiment, the both steps of producing the gap-filling adhesive and curing the gap-filling adhesive can be performed by light irradiation. Accordingly, during the production of the gap-filling adhesive, the three-dimensional shape of the gap-filling adhesive can be easily formed corresponding to the shape of the gap in the body to be adhered. Further, during curing the gap-filling adhesive, the gap-filling adhesive can be cured regardless of the heat resistance of the body to be adhered, and the change of the shape due to the thermal contraction is prevented. Therefore, the gap in the body to be adhered can be firmly filled the gap-filling adhesive with a good adhesiveness.

The molar absorption coefficient is intended to represent a range of wavelengths that the one of the photopolymerization initiators can generate active species of the polymerization reaction and the other of the photopolymerization initiators cannot substantially generate active species of the polymerization reaction. In other words, the resin composition according to the embodiment includes the radical-polymerizable compound, the cation-polymerizable compound, the photo radical photopolymerization initiator, and the photo cation photopolymerization initiator, and the resin composition has a range of wavelengths so that one of the photo radical photopolymerization initiator and the photo cation photopolymerization initiator can be activated and the other cannot be substantially activated. The phrase “cannot be substantially activated” means any active species is not generated at all or slightly generated even if the light having the range of wavelengths is sufficiently irradiated (to the extent that the polymerization reaction by the other polymerization initiator is sufficiently proceeded), and then the polymerization reaction of the resin composition by the initiator cannot proceeded as a whole.

Any radical-polymerizable compound may be used as long as it can radical-polymerize by using the photo radical photopolymerization initiator. Therefore, the radical-polymerizable compound is a compound having a radical-polymerizable group. The radical-polymerizable compound may be one having one radical-polymerizable group, or one having two or more radical-polymerizable groups. One type of the radical-polymerizable compound may be used alone, or two or more types of the radical-polymerizable compound may be used in combination thereof.

Desirably, the radical-polymerizable compound does not contain a functional group which inhibits the cation polymerization reaction. An example of the functional group includes a chlorine based functional group.

An example of the radical-polymerizable group includes a (meth)acryloyl group. Preferred radical-polymerizable group is a (meth)acryloyl group because the gap-filling adhesive having an improved adhesiveness to the body to be adhered is obtained. Therefore, preferred radical-polymerizable compound is one having a (meth)acryloyl group (hereinafter, also referred to as an acrylic compound).

An example of the acrylic compound includes a monofunctional acrylic compound having one (meth)acryloyl group and a multifunctional acrylic compound having two or more (meth)acryloyl groups. One of these compounds may be used alone, or two or more types of these compounds may be used in combination.

As the acrylic compound, a (meth)acrylate ester can be suitably used because of the difficulty in inhibiting the cation polymerization reaction and the ease of the compatibility with the cation-polymerizable compound.

Examples of the (meth)acrylate ester include an alkyl (meth)acrylate such as butyl (meth)acrylate or 2-ethylhexyl (meth)acrylate; an aromatic ring-containing (meth)acrylate such as benzyl (meth)acrylate or phenoxyethyl (meth)acrylate; and a heterocyclic ring-containing (meth)acrylate such as tetrahydrofurfulyl (meth)acrylate.

The radical-polymerizable compound may include a compound having a radical-polymerizable group and a cation-polymerizable group (hereinafter, also referred to as a crosslinkable compound). By including such a compound in the radical-polymerizable compound, a linking structure is formed between the polymer of the radical-polymerizable compound and the polymer of the cation-polymerizable compound, and then the adhesiveness and strength after curing of the gap-filling adhesive tends to be further improved.

For example, the crosslinkable compound may be a compound having a (meth)acryloyl group and an epoxy group. An example of the compound includes glycidyl (meth)acrylate.

The content of the crosslinkable compound in the radical-polymerizable compound is preferably 0.01% by mass or greater, and more preferably 0.1% by mass or greater based on the total amount of the radical-polymerizable compound. When the content is within the range, the above-described effects are remarkably exerted. For example, the content of the crosslinkable compound is preferably 20% by mass or less based on the total amount of the radical-polymerizable compound. When the content is within the range, gelation due to the excess cross-linking of the compound is prevented.

As used herein, the compound having a radical-polymerizable group and a cation-polymerizable group is considered as the radical-polymerizable compound for the description of the content as described below. That is, in the embodiment, the radical-polymerizable compound is one having a radical-polymerizable group, while the cation-polymerizable compound may be one having a cation-polymerizable group and no radical-polymerizable group.

Although the type of the photo radical photopolymerization initiator is not particularly limited, any initiator can be used as long as it can initiate the radical polymerization reaction of the radical-polymerizable compound. Examples of the photo radical photopolymerization initiator include bis(2, 4, 6-trimethylbenzoyl)-phenylphosphine oxide, and 2, 4, 6-trimethylbenzoyl-diphenyl-phosphine oxide.

The content of the photo radical photopolymerization initiator in the resin composition may be 0.01 parts by mass or greater, preferably 0.02 parts by mass or greater, and more preferably 0.05 parts by mass or greater based on 100 parts by mass of the radical-polymerizable compound. When the content is within the range, the radical polymerization reaction can be proceeded more sufficiently. The content of the photo radical photopolymerization initiator in the resin composition may also be 10 parts by mass or less based on 100 parts by mass of the radical-polymerizable compound. When the content is within the range, the radical polymerization reaction can be prevented from proceeding at once by dispersing, and overheating during the reaction and decreasing the molecular weight of the reacted products can be prevented.

Any cation-polymerizable compound may be used as long as it can be cation-polymerize by using the photo cation photopolymerization initiator. Therefore, the cation-polymerizable compound is a compound having a cation-polymerizable group.

Desirably, the cation-polymerizable compound does not contain a functional group which inhibits the radical polymeriaztion reaction.

Examples of the cation-polymerizable group include an epoxy group, an oxetane group, and a vinyl group. Among them, preferred cation-polymerizable group is an epoxy group because the gap-filling adhesive having an improved adhesiveness to the body to be adhered is obtained. Therefore, preferred cation-polymerizable compound is one having an epoxy group (hereinafter, also referred to as an epoxy based compound).

An example of the epoxy based compound includes a monofunctional epoxy based compound having one epoxy group and a multifunctional epoxy based compound having two or more epoxy groups. One of these compounds may be used alone, or two or more types of these compounds may be used in combination.

Examples of the epoxy based compound include a liquid-like epoxy based compound which is a liquid-like at 23° C. and a solid-like epoxy based compound which is a solid-like at 23° C. In the embodiment, one of these compounds may be used alone, or both compounds may be used in combination. In terms of the processability, the liquid-like epoxy based compound and the solid-like epoxy based compound are preferably used in combination.

An example of the liquid-like epoxy based compound includes a liquid-like bisphenol A type epoxy resin.

Commercially available liquid-like epoxy based compounds may be used as the liquid-like epoxy based compound. An example of the commercially available liquid-like epoxy based compound includes Epotote YD128R.

An example of the solid-like epoxy based compound includes a solid-like bisphenol A type epoxy resin.

Commercially available solid-like epoxy based compounds may be used as the solid-like epoxy based compound. An example of the commercially available solid-like epoxy based compound includes Epikote 1001.

When the liquid-like epoxy based compound and the solid-like epoxy based compound are used in combination, the ratio of the content of the solid-like epoxy based compound to one of the liquid-like epoxy compound (solid-like/liquid-like) may be 10% or greater, for example. The ratio is preferably 20% or greater, and more preferably 40% or greater. Furthermore, the ratio (solid-like/liquid-like) may be 95% or less. The ratio is preferably 90% or less, and more preferably 80% or less. When the ratio is within the range, the gap-filling adhesive has an effect that the adhesive is easily pressed and adhered while keeping its three-dimensional shape.

Although the type of the photo cation photopolymerization initiator is not particularly limited, any initiator can be used as long as it can initiate the cation polymerization reaction of the cation-polymerizable compound. An example of the photo cation photopolymerization initiator includes diphenyl[4-(phenylthio)phenyl]sulfonium hexafluoroantimonate.

The content of the photo cation photopolymerization initiator in the resin composition may be 0.1 parts by mass or greater, preferably 0.3 parts by mass or greater, and more preferably 0.5 parts by mass or greater based on 100 parts by mass of the cation-polymerizable compound. The content of the photo cation photopolymerization initiator in the resin composition may also be 20 parts by mass or less based on 100 parts by mass of the cation-polymerizable compound.

In the embodiment, one of the photo radical photopolymerization initiator and the photo cation photopolymerization initiator is sufficiently activated by the light absorption within a certain range of wavelengths. Therefore, in the embodiment, the gap-filling adhesive is produced by one of the radical-polymerizable compound and the cation-polymerizable compound, and the other of the radical-polymerizable compound and the cation-polymerizable compound is polymerized during curing of the gap-filling adhesive. Hereinafter, the compound which is formerly polymerized (that is, initialized the polymerization reaction by the polymerization initiator having a molar absorption coefficient of 1 or greater within the certain range of wavelengths) is referred as a first curable compound. The compound which is latterly polymerized (that is, polymerized during curing of the gap-filling adhesive) is referred as a second curable compound.

In the resin composition, the content of the first curable compound may be 30% by mass or greater based on the total amount of the first curable compound and the second curable compound. The content is preferably 50% by mass or greater, and more preferably 60% by mass or greater. When the content is within the range, the gap-filling adhesive is easily kept its three-dimensional shape, and tends to have an improved processability (and tends to harden). Further, the content of the first curable compound may be 95% by mass or less based on the total amount of the first curable compound and the second curable compound. The content is preferably 90% by mass or less, and more preferably 85% by mass or less. When the content is within the range, the gap-filling adhesive has an improved flexibility and tackiness, and tends to have improved filling properties to the body to be adhered (and tends to soften).

In terms of the availability of materials, the first curable compound is preferably the radical-polymerizable compound, and the second curable compound is preferably the cation-polymerizable compound. Therefore, in the embodiment, the resin composition preferably has a range of wavelengths so that the photo radical photopolymerization initiator has a molar absorption coefficient of 1 or greater (preferably 10 or greater) and the photo cation photopolymerization initiator has a molar absorption coefficient has a molar absorption coefficient of 0.1 or less (preferably 0.01 or less).

The combination of the photo radical photopolymerization initiator and the photo cation photopolymerization initiator is not particularly limited. Any suitable combination may be used depending on the range of absorption wavelengths for each initiator. Specific combination includes a combination of bis(2, 4, 6-trimethylbenzoyl)-phenylphosphine oxide, and diphenyl[4-(phenylthio)phenyl]sulfonium hexafluoroantimonate.

The resin composition is preferably a liquid-like composition at 23° C. because such a composition can be easily formed into the three-dimensional shape during the production of the gap-filling adhesive as described below. The resin composition does not have to contain a solvent. The composition may become a liquid-like composition by compatibilizing the radical-polymerizable compound and the cation-polymerizable compound.

The resin composition may further any other ingredient in addition to the ingredients described above. Examples of the other ingredient include a plasticizer, a flame retardant, a flame retardant aid, an anti-settling agent, a thickener, a surfactant, an anti-foaming agent, a colorant, a conductive particle, an anti-static agent, a metal deactivator, and an inorganic particle (a silica filler). For example, the content of the other ingredient may be 50% by mass or less based on the total amount of the radical-polymerizable compound and the cation-polymerizable compound.

### Gap-Filling Adhesive

The gap-filling adhesive according to the embodiment is a partially cured product of the above-described resin composition. The gap-filling adhesive according to the embodiment has a different composition depending on a combination of the photopolymerization initiator in the resin composition. In one suitable aspect, the gap-filling adhesive includes a polymer of the radical-polymerizable compound, the cation-polymerizable compound, and the photo cation photopolymerization initiator. Further, in another suitable aspect, the gap-filling adhesive includes a polymer of the radical-polymerizable compound, the cation-polymerizable compound, and the photo radical photopolymerization initiator.

The gap-filling adhesive according to the embodiment is an adhesive for filling the gap in the body to be adhered (for example, the recess in the surface, the gap between two surfaces, and the like). The gap-filling adhesive is one being capable of integrally forming a structure with the body to be adhered by adhering and curing with the body to be adhered. The gap-filling adhesive according to the embodiment is intended to adhere the cured product with the body to be adhered.

Preferably, the gap-filling adhesive has a three-dimensional shape corresponding to the gap in the body to be adhered. The gap-filling adhesive has improved filling properties to the gap in the body to be adhered. The filling operation becomes easier, and the appearance of the structure after filling can be improved. The three-dimensional shape of the gap-filling adhesive may be a shape which is generally identical to the gap to be filled, and may be a shape being capable of filling the gap by changing the shape of the gap-filling adhesive because of the pressure during filling.

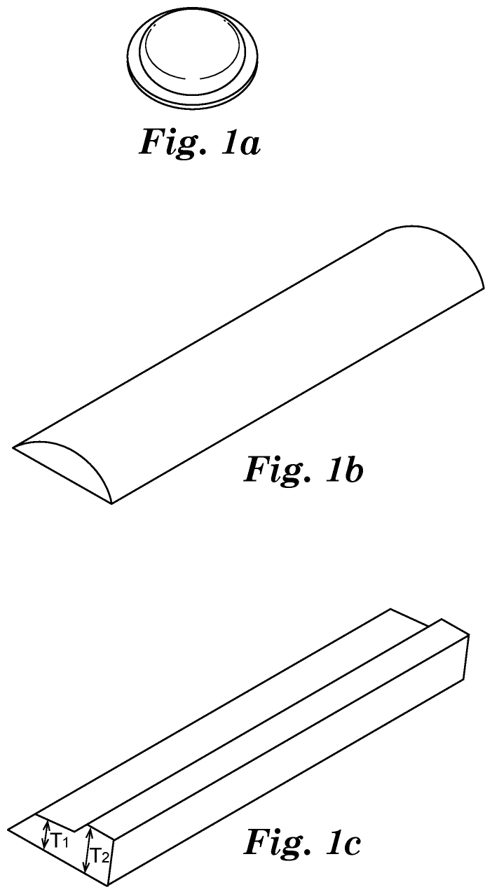

FIG. 1A is a schematic perspective view showing one embodiment of the gap-filling adhesive. FIGS. 1B and 1C are schematic perspective views illustrating other embodiments of the gap-filling adhesive. An example of the three-dimensional shape includes a shape having a convex as the top, such as a dome-shape (spherical segment) illustrated in FIG. 1A. Further examples of the three dimensional shape include a column-shaped structure having a certain shape as the bottom surface as illustrated in FIG. 1B and FIG. 1C (a circular segment in FIG. 1B, and a shape composed of a segment having a height T1 from the bottom side and a segment having a height T2 which is larger than T1 in FIG. 1C). The three-dimensional shape is not limited to these shapes. The three-dimensional shape may be suitably modified depending on the gap in the body to be adhered.

Preferably, the gap-filling adhesive has a 25% compression load of 2.5 N/cm² or greater. The three-dimensional shape of the gap-filling adhesive is not easily broken, and the gap-filling adhesive has an improved handleability. Note that the 25% compression load is represented as an amount by measuring according the method that meets the requirements of the standard JIS K 6767.

In terms of exerting the effects remarkably, the 25% compression is more preferably 2.0 N/cm² or greater, and more further preferably 3.0 N/cm² or greater.

Preferably, the gap-filling adhesive has a 25% compression load of 6 N/cm² or less. The gap-filling adhesive easily change the shape during filling of the gap in the body to be adhered so that the shape is changed corresponding to the shape of the gap, and then the gap-filling adhesive has improved filling properties and processability.

In terms of exerting the effects remarkably, the 25% compression load is more preferably 7.0 N/cm² or less, and more further preferably 6.0 N/cm² or less.

In order to increase the 25% compression load of the gap-filling adhesive, the content of the first curable compound may be increased based on the total amount of the first curable compound and the second curable compound in the resin composition. When the liquid-like epoxy based compound and the solid-like epoxy based compound are used in combination, the ratio of the content of the solid-like epoxy based compound to one of the liquid-like epoxy compound may be increased. In order to decrease the 25% compression load of the gap-filling adhesive, the content of the first curable compound may be decreased based on the total amount of the first curable compound and the second curable compound in the resin composition. When the liquid-like epoxy based compound and the solid-like epoxy based compound are used in combination, the ratio of the content of the solid-like epoxy based compound to one of the liquid-like epoxy compound may be decreased.

Preferably, the change of the volume of the gap-filling adhesive before and after curing is small. For example, the gap-filling adhesive preferably has a ratio of the volume after curing and releasing the compression force to one N/cm² before curing and under compression is 0.9 or greater.

The gap-filling adhesive according to the embodiment can be obtained by irradiating the above-described resin composition with a light having the certain range of wavelengths to partially polymerize the composition. In the embodiment, the gap-filling adhesive having a certain shape may be obtained by partially polymerizing the resin composition while keeping it in the certain shape. For example, the gap-filling adhesive having a three-dimensional shape can be obtained by partially polymerizing the resin composition in a condition in that the composition is filled into a mold having the three dimensional shape.

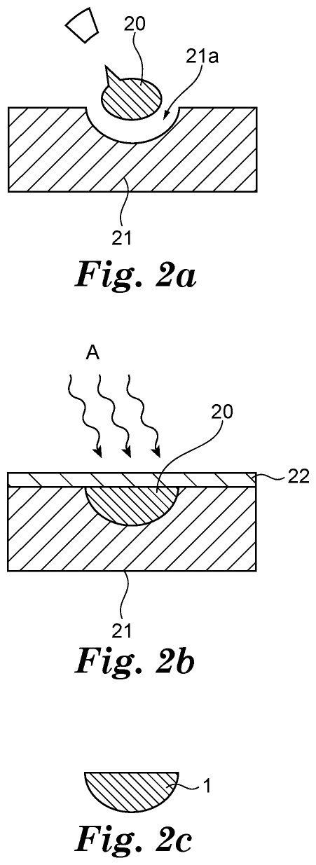

FIGS. 2A to 2C are cross-sectional views showing steps according to one embodiment of the production method of the gap-filling adhesive. In the production method, as illustrated in FIG. 2A, the resin composition 20 is firstly filled into a cavity 21a of the mold 21 having a three-dimensional shape. In this case, the releasing treatment may be performed on the surface of the mold 21 in order to easily release the gap-filling adhesive from the mold 21 after partially curing. An example of the releasing treatment includes a method of treating a surface with silicone.

Next, as illustrated in FIG. 2B, the resin composition 20 filled in the mold 21 is irradiated with the light having the certain range of wavelengths A to partially polymerize the resin composition. The photo radical photopolymerization initiator or the photo cation photopolymerization initiator in the resin composition is activated by the light A, and then the polymerization reaction of the radical-polymerizable compound or the cation-polymerizable compound is proceeded.

In that time, a film 22 may be positioned on the resin composition 20. By positioning the film 22, the gap-filling adhesive having a smooth surface on the opposite side of the three-dimensional shape can be formed. Further, by positioning the film 22, oxygen and moisture which inhibit the polymerization reaction are prevent from penetrating, and then the resin composition 20 can be partially polymerized more efficiently.

When the film 22 is positioned, the light A is irradiated to the resin composition 20 through the film 22. Therefore, the film 22 preferably has a transparency against the light A. The film 22 preferably has a transmittance of 60% or greater against the light A. More preferably, the transmittance is 80% or greater.

As the film 22, for example, PET, polyethylene, and the like can be suitably used.

In terms of irradiating with the light A having the certain range of wavelengths effectively, a light source such as an LED lamp can be suitably used.

As illustrated in FIG. 2C, the gap-filling adhesive 1 obtained by the partially polymerization has a three-dimensional shape corresponding to the shape of the mold 21. In FIG. 2C, although the gap-filling adhesive 1 after releasing the film 22 is illustrated, the gap-filling adhesive 1 may be stored and/or conveyed in a condition that a part of the gap-filling adhesive 1 is covered with the film 22.

The gap-filling adhesive according to the embodiment is filled in the gap in the body to be adhered, and then cured by the light irradiation. For example, the gap-filling adhesive may be cured in a pressed condition against the gap in the body to be adhered.

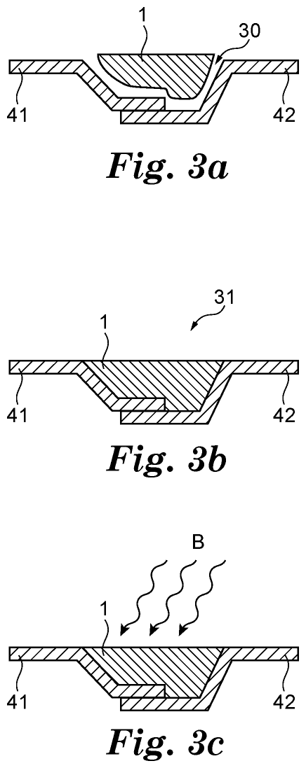

FIGS. 3A to 3C are cross-sectional views illustrating steps according to one embodiment of the filling method of the gap. Hereinafter, as illustrated in FIG. 3A, the method of filling the gap 30 in a recession shape formed in the mated part between the first member 41 and the second member 42 with the gap-filling adhesive 1 will be described.

Firstly, as illustrated in FIG. 3B, the gap 30 is filled with the gap-filling adhesive 1 by pressing the gap-filling adhesive 1 from the opposite side 31 to the gap 30. In this case, since the gap-filling adhesive 1 has a three-dimensional shape, the whole area of the gap 30 can be easily filled with the gap-filling adhesive 1.

Next, as illustrated in FIG. 3C, the gap-filling adhesive 1 is cured by irradiating the gap-filling adhesive 1 filled in the gap 30 with the light B. In this case, the wavelength of the light B is not particularly limited. Any light may be used as long as the light B has a range of wavelengths being capable of activating the polymerization initiator contained in the gap-filling adhesive 1 (the photo radical photopolymerization initiator or the photo cation photopolymerization initiator). By irradiating with the light B, the cured product of the gap-filling adhesive 1 (hereinafter, also referred to as an adhesive cured product) is formed in the gap 30.

The gap-filling adhesive 1 may be cured in a pressed condition against the gap 30. For example, the gap-filling adhesive 1 may be cured while keeping the pressure against the gap 30 during filling, or the gap-filling adhesive 1 may be pressed after filling in the gap, and then cured. According to the method, the adhesiveness of the adhesive cured product against the body to be adhered (the first member 41 and the second member 42) tends to be improved. Further, the surfaces of the gap 30 and the opposite surface tend to remain as a smooth surface, and the design after curing tends to be improved.

The adhesive cured product integrally forms a shaped article with the body to be adhered. The required properties of the adhesive cured product are varied depending on the application of the shaped article. For example, the pencil hardness is preferably B or higher. The pencil hardness of the adhesive cured product may be F or higher, or H or higher. Note that the pencil hardness is measured according the method that meets the requirements of the standard JIS K 5600-5-4.

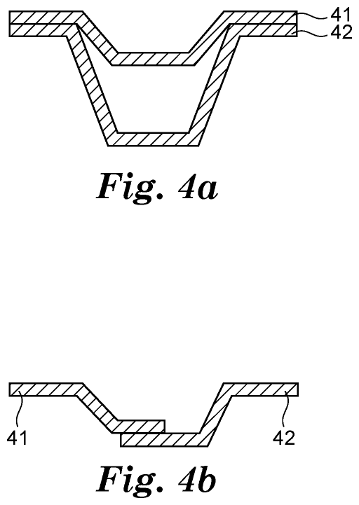

Recently, in a motor vehicle, the method for reducing the weight of the vehicle body is explored in terms of improving the fuel efficiency. For example, an exterior panel as one component of the vehicle body is usually composed of two layers, an inner panel 41 and an outer panel 42 for achieving the design, as illustrated in FIG. 4A. In order to decrease the weight of the vehicle body, as illustrated in FIG. 4B, a configuration formed by removing a part of the outer panel 42 and exposing the inner panel 41, and adhering both panels with an adhesive is attempted. The gap-filling adhesive according to the embodiment can be suitably used in the application for filling the gap formed the connecting part between the inner panel 41 and the outer panel 42.

Further, the gap-filling adhesive according to the embodiment can be applied to the application for filling the gap of the structure, for example. In particular, the gap-filling adhesive can be applied to the exterior coating which is exposed to outside air and requiring autohesion. Additionally, since the gap-filling adhesive can form into a three-dimensional shape, the adhesive can be applied to a gap having a complicated shape. Further, since the adhesion of the gap-filling adhesive to the undesired position can be decreased, the adverse effect to the surface of the member (for example, the painted surface) due to removing the excess adhesive by polishing can be prevented. Therefore, it is suitable for keeping the excellent design. As the location to be applied, for example, the adhesive can be suitably used for the application of the outer steel plate in the motor vehicle, aircraft, or robot.

Although descriptions were given above for the preferred embodiments of the present invention, the present invention is not limited to the aforementioned embodiments.

### EXAMPLES

The present invention will be described more specifically below using examples, but the present invention is not intended to be limited to the examples.

### Examples 1 to 15

### Preparation of Resin Compositions

The resin compositions were obtained by charging each ingredient shown in Tables 1 to 4 in a formulating proportion (ratio by weight) shown in Tables 1 to 4 into a planetary mixer, kneading the ingredients under reduced pressure (0.01 MPa) for 30 min, removing air and mixing to obtain a resin composition.

TABLE 1

| | | Examples | Examples | Examples |
|---|---|---|---|---|
| | | 1 | 2 | 3 |
| Radical- | 2EHA | 16 | — | — |
| polymerizable | BzA | 8 | 10 | — |
| compound | 2POEA | 76 | 90 | — |
| | THFA | — | — | 100 |
| | GMA | 3 | 3 | 3 |
| Cation- | Epikote 1001 | 35 | 35 | 70 |
| polymerizable | Epotote YD128R | 35 | 35 | — |
| compound | | | | |
| Photo radical | Irgacure819 | 0.1 | 0.1 | 0.1 |
| photopolymerization | | | | |
| initiator | | | | |
| Photo cation | CPI-101A | 0.7 | 0.7 | 0.7 |
| photopolymerization | | | | |
| initiator | | | | |

| | | | |
|---|---|---|---|
| Radical-polymerizable compound/cation- | 1.4 | 1.4 | 1.4 |
| polymerizable compound | | | |
| Solid-like epoxy/liquid-like epoxy | 1 | 1 | — |

TABLE 2

| | | Examples | Examples | Examples | Examples |
|---|---|---|---|---|---|
| | | 4 | 5 | 6 | 7 |
| Radical- | 2EHA | — | — | — | — |
| polymerizable | BzA | — | — | — | — |
| compound | 2POEA | — | — | — | — |
| | THFA | 100 | 100 | 100 | 100 |
| | GMA | 3 | 3 | 3 | 3 |
| Cation- | Epikote 1001 | 8 | 16 | 24 | 32 |
| polymerizable | Epotote YD128R | 32 | 24 | 16 | 8 |
| compound | | | | | |
| Photo radical | Irgacure819 | 0.1 | 0.1 | 0.1 | 0.1 |
| photopolymerization | | | | | |
| initiator | | | | | |
| Photo cation | CPI-101A | 0.4 | 0.4 | 0.4 | 0.4 |
| photopolymerization | | | | | |
| initiator | | | | | |

| | | | | |
|---|---|---|---|---|
| Radical-polymerizable compound/cation- | 2.5 | 2.5 | 2.5 | 2.5 |
| polymerizable compound | | | | |
| Solid-like epoxy/liquid-like epoxy | 0.3 | 0.7 | 1.5 | 4.0 |

TABLE 3

| | | Examples | Examples | Examples | Examples |
|---|---|---|---|---|---|
| | | 8 | 9 | 10 | 11 |
| Radical- | 2EHA | — | — | — | — |
| polymerizable | BzA | — | — | — | — |
| compound | 2POEA | — | — | — | — |
| | THFA | 100 | 100 | 100 | 100 |
| | GMA | 3 | 3 | 3 | 3 |
| Cation- | Epikote 1001 | 14 | 28 | 42 | 56 |
| polymerizable | Epotote YD128R | 56 | 42 | 28 | 14 |
| compound | | | | | |
| Photo radical | Irgacure819 | 0.1 | 0.1 | 0.1 | 0.1 |
| photopolymerization | | | | | |
| initiator | | | | | |
| Photo cation | CPI-101A | 0.7 | 0.7 | 0.7 | 0.7 |
| photopolymerization | | | | | |
| initiator | | | | | |

| | | | | |
|---|---|---|---|---|
| Radical-polymerizable compound/cation- | 1.4 | 1.4 | 1.4 | 1.4 |
| polymerizable compound | | | | |
| Solid-like epoxy/liquid-like epoxy | 0.3 | 0.7 | 1.5 | 4.0 |

TABLE 4

| | | Examples | Examples | Examples | Examples |
|---|---|---|---|---|---|
| | | 12 | 13 | 14 | 15 |
| Radical- | 2EHA | — | — | — | — |
| polymerizable | BzA | — | — | — | — |
| compound | 2POEA | — | — | — | — |
| | THFA | 100 | 100 | 100 | 100 |
| | GMA | 3 | 3 | 3 | 3 |
| Cation- | Epikote 1001 | 20 | 40 | 60 | 80 |
| polymerizable | Epotote YD128R | 80 | 60 | 40 | 20 |
| compound | | | | | |
| Photo radical | Irgacure819 | 0.1 | 0.1 | 0.1 | 0.1 |
| photopolymerization | | | | | |
| initiator | | | | | |
| Photo cation | CPI-101A | 1 | 1 | 1 | 1 |
| photopolymerization | | | | | |
| initiator | | | | | |

| | | | | |
|---|---|---|---|---|
| Radical-polymerizable compound/cation- | 1.0 | 1.0 | 1.0 | 1.0 |
| polymerizable | | | | |
| compound | | | | |
| Solid-like epoxy/liquid-like epoxy | 0.3 | 0.7 | 1.5 | 4.0 |

Each of the abbreviations shown in Tables 1-4 has the following meaning.

### Radical-Polymerizable Compounds

2EHA: 2-ethylhexyl acrylate
BzA: benzyl acrylate
2POEA: 2-phenoxyethyl acrylate
THFA: tetrahydrofurfuryl acrylate
GMA: glycidyl methacrylate

### Cation-Polymerizable Compounds

Epikote 1001: available from Mitsubishi Chemical Corporation, solid-like epoxy resin.
Epotote YD128R: available from NIPPON STEEL & SUMIKIN CHEMICAL CO., LTD., liquid-like epoxy resin.

### Photo Radical Photopolymerization Initiators

Irgacure 819: manufactured by BASF, bis(2, 4, 6-trimethylbenzoyl)-phenylphosphine oxide having a molar absorption coefficient at 405 nm light: 8.99×10².

### Photo Cation Photopolymerization Initiators

CPI-101A: available from San-Apro Ltd., triaryl sulfonium salt having a molar absorption coefficient at 365 nm light: 80.

### Production of Gap-Filling Adhesive

The resin composition was filled in a mold having a certain cavity. A film was laminated on the filled resin composition so that air was not entrapped. Next, the resin composition was irradiated with a light having a wavelength of 405 nm by using a LED lamp from the film side of the laminate to partially cure the resin composition (the irradiation condition: 5 mW/cm² and 10 min) and to obtain a gap-filling adhesive.

The resulting gap-filling adhesive had a three-dimensional shape corresponding to the shape of the cavity in the mold. Properties of the resulting gap-filling adhesive were evaluated by the following methods. The evaluation results are shown in Tables 5 to 8.

### 25% Compression Load

The 25% compression load of the gap-filling adhesive was measured according the method that meets the requirements of the standard JIS K 6767. More specifically, samples of the gap-filling adhesive having 25 mm×25 mm×2 mm (thickness) were prepared. The samples were laminated so that the total thickness became about 10 mm to produce a test sample. The accurate thickness of the test sample was measured. Next, the test sample was compressed at a compression speed of 10 mm/min by a Compression Testing Apparatus (available from Shimadzu Corporation, AUTOGRAPH AG-X). The compression load of the test sample was measured when the test sample was compressed to 25% of the original thickness. The atmosphere condition during the test was a standard condition (23±2° C., 50±5% RH).

### Thickness Recovery

A sample of the gap-filling adhesive having 10 mm×10 mm×2 mm (thickness) were prepared. The sample was sandwiched between a transparent PP plate and a SUS plate. Thereafter, the sample was compressed until the thickness of the sample was 1.5 mm (25% compression), and kept it in the condition for 1 min. The sample was irradiated with LED having a wavelength of 365 nm at 5 J through the transparent PP plate while compressing, and kept it in the condition for 3 min. Thereafter, the compression force was released and the PP plate was removed. After 10 min, the thickness of the sample was measured, and the thickness recovery was calculated.

### Shear Adhesive Strength

A sample of the gap-filling adhesive having 12 mm (shorter side)×25 mm (longer side)×1 mm (thickness) was prepared. The release paper on one side of the sample was released, and the sample was adhered to a SUS plate. The release paper on the other side of the sample was released. The sample was irradiated with a UV-LED having a wavelength of 365 nm at 5 J. Just after UV irradiation, an electrodeposition painting plate was applied to the opposite surface of the adhesive on the SUS plate to produce a test sample, and the sample was conditioned for 24 hours (23° C., 50% RH). Thereafter, the shear adhesive strength was measured at a tensile speed of 50 mm/min against the shorter side of the sample.

### Pencil Hardness

The sample was irradiated with UV-LED having a wavelength of 365 nm at 5 J, and then the sample was conditioned for 24 hours (23° C., 50% RH) to cure the gap-filling adhesive and to obtain an adhesive cured product. The resulting adhesive cured product was measured for pencil hardness by the method that meets the requirements of the standard JIS K 5600-5-4.

TABLE 5

| | Example | Example | Example |
|---|---|---|---|
| | 1 | 2 | 3 |
| 25% compression load (N/cm²) | 4.3 | 5.8 | 6.6 |
| Thickness recovery (%) | 3 | 5 | 7 |
| Shear adhesive strength (MPa) | 1.7 | 3.2 | 3.4 |
| Pencil hardness | — | 3B | F |

TABLE 6

| | Example | Example | Example | Example |
|---|---|---|---|---|
| | 4 | 5 | 6 | 7 |
| 25% compression load (N/cm²) | 3.3 | 3.5 | 4.3 | 5.8 |
| Thickness recovery (%) | 5 | 8 | 8 | 8 |
| Shear adhesive strength (MPa) | 2.9 | 3.1 | 3.3 | 3.8 |
| Pencil hardness | B | B | B | B |

TABLE 7

| | Example | Example | Example | Example |
|---|---|---|---|---|
| | 8 | 9 | 10 | 11 |
| 25% compression load (N/cm²) | 2.1 | 2.9 | 3.9 | 5.3 |
| Thickness recovery (%) | 3 | 5 | 7 | 7 |
| Shear adhesive strength (MPa) | 2.6 | 2.2 | 2.3 | 2.8 |
| Pencil hardness | F | F | F | F |

TABLE 8

| | Example | Example | Example | Example |
|---|---|---|---|---|
| | 12 | 13 | 14 | 15 |
| 25% compression load (N/cm²) | 2.0 | 2.2 | 3.2 | 3.7 |
| Thickness recovery (%) | 1 | 1 | 3 | 5 |
| Shear adhesive strength (MPa) | 2.0 | 1.9 | 1.6 | 1.8 |
| Pencil hardness | H | H | H | H |

1. A gap-filling adhesive which is a partially polymerized product of a resin composition comprising a radical-polymerizable compound, a cation-polymerizable compound, a photo radical photopolymerization initiator, and a photo cation photopolymerization initiator,
wherein the resin composition has a range of wavelengths such that one of the photo radical photopolymerization initiator and the photo cation photopolymerization initiator has a molar absorption coefficient of 1 or greater, and the other has a molar absorption coefficient of 0.1 or less, the gap-filling adhesive comprises a polymer of the radical-polymerizable compound, the cation-polymerizable compound, and the photo cation photopolymerization initiator, or the gap-filling adhesive comprises the radical-polymerizable compound, the polymer of the cation-polymerizable compound, and the photo radical photopolymerization initiator, and the gap-filling adhesive has a three-dimensional shape corresponding to the shape of the gap to be filled.

2. The gap filling adhesive according to claim 1, wherein the resin composition has a range of wavelengths such that the photo radical photopolymerization initiator has a molar absorption coefficient of 10 or greater, and the photo cation photopolymerization initiator has a molar absorption coefficient has a molar absorption coefficient of 0.01 or less.

3. The gap filling adhesive according to claim 1, wherein the radical-polymerizable compound contains a compound having a (meth)acryloyl group.

4. The gap filling adhesive according to claim 1, wherein the cation-polymerizable compound contains a compound having an epoxy group.

5. The gap filling adhesive according to claim 4, wherein the compound having an epoxy group contains a liquid-like epoxy based compound which is a liquid-like at 23° C. and a solid-like epoxy based compound which is a solid-like at 23° C.

6. The gap-filling adhesive according to claim 1, wherein the gap-filling adhesive has a 25% compression load of 2.0 to 7.0 N/cm².

7. The gap-filling adhesive according to claim 1, wherein three-dimensional shape of the gap-filling adhesive has a convex shape corresponding to the shape of the gap recesses in the surface.

8. The gap-filling adhesive according to claim 1, where the gap-filling adhesive is capable of filling the gap by changing the shape of the gap-filling adhesive because of pressure being applied during filling.

9. A method of producing the gap-filling adhesive according to claim 1, said method comprising partially curing step of partially curing the resin composition with the light having the certain range of wavelengths.

10. The method according to claim 9, wherein in the partially curing step, the resin composition is partially cured in a condition in that the composition is filled into a mold having the three-dimensional shape.

11. A filling method of the gap, comprising:
a filling step of filling the gap with the gap-filling adhesive according to claim 1; and
a curing step of curing the gap-filling adhesive filled in the gap.

12. The gap filling adhesive according to claim 2, wherein the radical-polymerizable compound contains a compound having a (meth)acryloyl group.

13. The gap filling adhesive according to claim 2, wherein the cation-polymerizable compound contains a compound having an epoxy group.

14. The gap filling adhesive according to claim 12, wherein the cation-polymerizable compound contains a compound having an epoxy group.

15. The gap-filling adhesive according to claim 2, wherein the gap-filling adhesive has a 25% compression load of 2.0 to 7.0 N/cm².

16. The gap-filling adhesive according to claim 14, wherein the gap-filling adhesive has a 25% compression load of 2.0 to 7.0 N/cm².

17. The gap-filling adhesive according to claim 1, wherein three-dimensional shape of the gap-filling adhesive has an exposed top surface.

18. The gap-filling adhesive according to claim 6, where the gap-filling adhesive is capable of filling the gap by changing the shape of the gap-filling adhesive because of pressure being applied during filling.

19. The gap-filling adhesive according to claim 16, where the gap-filling adhesive is capable of filling the gap by changing the shape of the gap-filling adhesive because of pressure being applied during filling.

20. A body having a recess filled with the gap-filling adhesive according to claim 1, wherein the gap-filling adhesive has a three-dimensional shape corresponding to the shape of the recess and an exposed top surface.
